(19) United States
(12) Patent Application Publication
(10) Pub. No.: US 2003/0055707 A1
(43) Pub. Date: Mar. 20, 2003

(54) METHOD AND SYSTEM FOR INTEGRATING SPATIAL ANALYSIS AND DATA MINING ANALYSIS TO ASCERTAIN FAVORABLE POSITIONING OF PRODUCTS IN A RETAIL ENVIRONMENT

(76) Inventors: FREDERICK D. BUSCHE, HIGHLAND VILLAGE, TX (US); DAVID MARCOTTE, HAMPDEN, MA (US)

Correspondence Address: GREGORY M DOUDNIKOFF, IBM CORPORATION DEPT T81/062, 3039 CORNWALLIS ROAD, RTP, NC, 27709

(21) Appl. No.: 09/400,583

(22) Filed: Sep. 22, 1999

(51) Int. Cl. G06F 17/60

(52) U.S. Cl. 705/10; 705/26

(57) ABSTRACT

A method and system for ascertaining the favorable positioning of products in a retail environment is provided. The locations of products within a retail space are determined using a position identifying system, such as a global positioning system, a local positioning system, or an enhanced global positioning system as products are stocked within the retail space. The paths of customers through the retail space are also determined using the position identifying system, and these paths may be sensed and recorded using a device that stores a position identifier broadcast by the position identifying system. Customers may be identified using financial transaction databases or other identifying data. The products chosen for purchase by the customers are identified, and the locations of the chosen products within the retail space are associated with the paths of the customers through the retail space to form a set of spatial relationships. Data mining algorithms are used to generate input data for forming a set of spatial relationships. Spatial analysis techniques are used to formulate the set of spatial relationships.

### CROSS REFERENCE TO RELATED APPLICATIONS

The present invention is related to the following applications entitled “METHOD AND SYSTEM FOR INTEGRATING SPATIAL ANALYSIS AND DATA MINING ANALYSIS TO ASCERTAIN WARRANTY ISSUES ASSOCIATED WITH TRANSPORTATION PRODUCTS”, U.S. application Ser. No. ______, Attorney Docket Number CR9-99-050; and “METHOD AND SYSTEM FOR INTEGRATING SPATIAL ANALYSIS AND DATA MINING ANALYSIS TO ASCERTAIN RELATIONSHIPS BETWEEN COLLECTED SAMPLES AND GEOLOGY WITH REMOTELY SENSED DATA”, U.S. application Ser. No. ______, Attorney Docket Number CR9-99-051; all of which are filed even date hereof, assigned to the same assignee, and incorporated herein by reference.

### BACKGROUND OF THE INVENTION

1. Technical Field

The present invention relates to an improved data processing system and, in particular, to a method and system for a specific business application of database processing.

2. Description of Related Art

As businesses become more productive and profit margins seem to be reduced, relationships between businesses and its customers become more valuable. Businesses are more willing to protect those relationships by spending more money on information technology. Because an enterprise may collect significant amounts of data concerning their operations and the flow of goods to and from the enterprise, some of the expenditures on information technology are used to “mine” these collections of data to discover customer relationships that are useful to the enterprise.

Data mining allows a user to search large databases and to discover hidden patterns in that data. Data mining is thus the efficient discovery of valuable, non-obvious information from a large collection of data and centers on the automated discovery of new facts and underlying relationships in the data. The term “data mining” comes from the idea that the raw material is the business data, and the data mining algorithm is the excavator, shifting through the vast quantities of raw data looking for the valuable nuggets of business information.

Businesses constantly desire a better understanding of a customer's buying habits in a retail establishment, and data mining has been used in an attempt to discover relationships between customers and purchases. One class of relationships for which a business desires guidance is the relationship between product placement and the choice of products for purchases by the customers of the business, which may own several databases from which such relationships could be extracted if the proper methodologies could be applied. However, data mining analysis heretofore has been concerned primarily with relationships between customer characteristics and product characteristics and not the relationships between customers and the placement of products within a retail environment.

Therefore, it would be advantageous to provide a method and system for data analysis that discovers relationships between product placement and the choice of product purchases by a customer.

### SUMMARY OF THE INVENTION

A method and system for ascertaining the favorable positioning of products in a retail environment is provided. The locations of products within a retail space are determined using a position identifying system, such as the global positioning system (GPS), a local positioning system (LPS), or an enhanced global positioning system (EGPS), and their positions are captured in a database attached to a spatial analysis system such as a Geographic Information System (GIS) as products are stocked within the retail space. The paths of customers through the retail space are also determined using the position identifying system, and these paths may be recorded using a device that stores a position identifier broadcast by the position identifying system. Customers may be identified using financial transaction databases or other identifying data. The products chosen for purchase by the customers are identified, and the locations of the chosen products within the retail space are associated with the paths of the customers through the retail space to form a set of spatial relationships. Data mining algorithms are used to generate input data for forming a set of product and customer relationships. The spatial analysis techniques of GIS, combined with the location technologies of GPS, LPS, and EGPS, are used to formulate and capture the set of spatial relationships.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 is a block diagram illustrating a data processing system in which the present invention may be implemented;

FIG. 3 is a block diagram depicting various objects upon which a retail establishment may gather information to determine spatial relationships;

FIG. 4 is a block diagram depicting the components that may be used in a data processing system implementing the present invention; and

FIG. 5 is a flowchart depicting a process for integrating spatial analysis with data mining.

### DETAILED DESCRIPTION OF THE PREFERRED EMBODIMENT

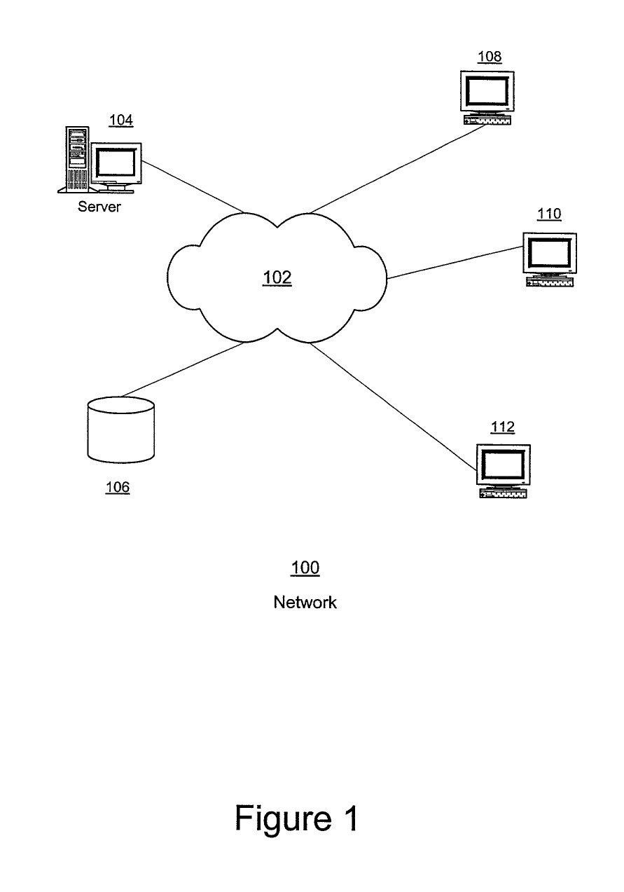

With reference now to the figures, FIG. 1 depicts a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections.

In the depicted example, a server 104 is connected to network 102 along with storage unit 106. In addition, clients 108, 110, and 112 also are connected to a network 102. These clients 108, 110, and 112 may be, for example, personal computers or point-of-sale systems, such as electronic cash registers. In the depicted example, server 104 provides data, such as boot files, operating system images, and applications to clients 108-112. Clients 108, 110, and 112 are clients to server 104. Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, distributed data processing system 100 also may be implemented as a number of different types of networks, such as for example, an intranet, a local area network (LAN), or a wide area network (WAN). FIG. 1 is intended as an example, and not as an architectural limitation for the present invention.

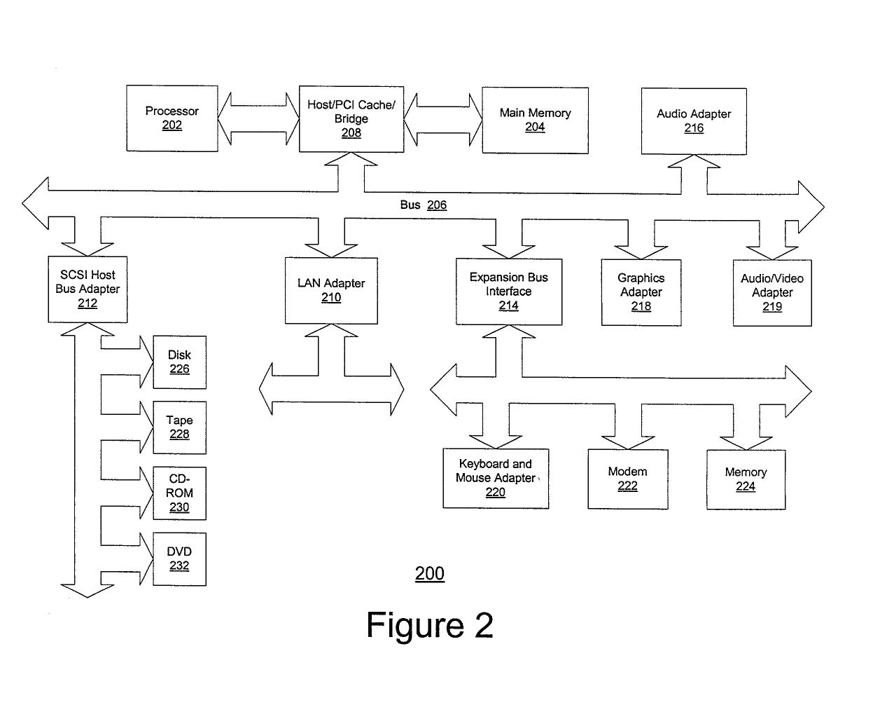

With reference now to FIG. 2, a block diagram illustrates a data processing system in which the present invention may be implemented. Data processing system 200 is an example of a client computer. Data processing system 200 employs a peripheral component interconnect (PCI) local bus architecture. Although the depicted example employs a PCI bus, other bus architectures, such as Micro Channel and ISA, may be used. Processor 202 and main memory 204 are connected to PCI local bus 206 through PCI bridge 208. PCI bridge 208 may also include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter (A/V) 219 are connected to PCI local bus 206 by add-in boards inserted into expansion slots. Expansion bus interface 214 provides a connection for a keyboard and mouse adapter 220, modem 222, and additional memory 224. In the depicted example, SCSI host bus adapter 212 provides a connection for hard disk drive 226, tape drive 228, CD-ROM drive 230, and digital video disc read only memory drive (DVD-ROM) 232. Typical PCI local bus implementations will support three or four PCI expansion slots or add-in connectors. An operating system runs on processor 202 and is used to coordinate and provide control of various components within data processing system 200 in FIG. 2. The operating system may be a commercially available operating system, such as OS/2, which is available from International Business Machines Corporation. “OS/2” is a trademark of International Business Machines Corporation. An object oriented programming system, such as Java, may run in conjunction with the operating system, providing calls to the operating system from Java programs or applications executing on data processing system 200. Instructions for the operating system, the object-oriented operating system, and applications or programs are located on a storage device, such as hard disk drive 226, and may be loaded into main memory 204 for execution by processor 202.

Those of ordinary skill in the art will appreciate that the hardware in FIG. 2 may vary depending on the implementation. For example, other peripheral devices, such as optical disk drives, systems using AIX or Unix as operating systems and the like, may be used in addition to or in place of the hardware depicted in FIG. 2. The depicted example is not meant to imply architectural limitations with respect to the present invention. For example, the processes of the present invention may be applied to multiprocessor data processing systems.

As the present invention relies extensively on the relatively new field of data mining and uses data mining algorithms without proffering a new data mining algorithm per se, a discussion of the general techniques and purposes of data mining are herein provided before a detailed discussion of the implementation of the present invention.

Background on Data Mining

Data mining is a process for extracting relationships in data stored in database systems. As is well-known, users can query a database system for low-level information, such as how many compact disks did a particular consumer purchase in the last month. Data mining systems, on the other hand, can build a set of high-level rules about a set of data, such as “If the purchaser is a student and between the ages of 16 and 21, then the probability of buying a compact disk is eighty percent.” Such rules allow a manager to make queries, such as “Which customers have the highest probability of buying a compact disk?” This type of knowledge allows for targeted marketing of products and helps to guide other strategic business decisions. Applications of data mining include finance, market data analysis, medical diagnosis, scientific tasks, VLSI design, analysis of manufacturing processes, etc. Data mining involves many aspects of computing, including, but not limited to, database theory, statistical analysis, artificial intelligence, and parallel/distributed computing.

Data mining may be categorized into several tasks, such as association, classification, and clustering. There are also several knowledge discovery paradigms, such as rule induction, instance-based learning, neural networks, and genetic algorithms. Many combinations of data mining tasks and knowledge discovery paradigms are possible within a single application.

Data Mining Tasks

An association rule can be developed based on a set of data for which an attribute is determined to be either present or absent. For example, suppose data has been collected on purchases by customers at a store and the attributes are whether specific items were purchased or not for each of the transactions. The goal is to discover any association rules between the purchase of some items and the purchase of other items. Specifically, given two non-intersecting sets of items, e.g., sets X and Y, one may attempt to discover whether there is a rule “if X was purchased, then Y was purchased,” and the rule is assigned a measure of support and a measure of confidence that is equal or greater than some selected minimum levels. The measure of support is the ratio of the number of records where both X and Y were purchased divided by the total number of records. The measure of confidence is the ratio of the number of records where both X and Y were purchased divided by the number of records where X was purchased. Due to the smaller set of transactions in the denominators of these ratios, the minimum acceptable confidence level is higher than the minimum acceptable support level. Returning to shopping transactions as an example, the minimum support level may be set at 0.3 and the minimum confidence level set at 0.8. An example rule in a set of grocery store transactions that meets these criteria might be “if bread was purchased, then butter was purchased.”

Given a set of data and a set of criteria, the process of determining associations is completely deterministic. Since there are a large number of subsets possible for a given set of data and a large number of transactions to be processed, most research has focused on developing efficient algorithms to find all associations. However, this type of inquiry leads to the following question: Are all discovered associations really significant? Although some rules may be interesting, one finds that most rules may be uninteresting since there is no cause and effect relationship. For example, the association “if butter was purchased, then bread was purchased” would also be a reported associated with exactly the same support and confidence values as the association “if bread was purchased, then butter was purchased,” even though one would assume that the purchase of butter was possibly caused by the purchase of bread and not vice versa.

Classification tries to discover rules that predict whether a record belongs to a particular class based on the values of certain attributes. In other words, given a set of attributes, one attribute is selected as the “goal,” and one desires to find a set of “predicting” attributes from the remaining attributes. For example, suppose it is desired to know whether a particular item will be purchased based on the gender, country of origin, and age of the purchaser. For example, this type of rule could include “If the person is from France and over 25 years old, then they will not purchase the item.” A set of data is presented to the system based on past knowledge; this data “trains” the system. The goal is to produce rules that will predict behavior for a future class of data. The main task is to design effective algorithms that discover high quality knowledge. Unlike association in which one may develop definitive measures for support and confidence, it is much more difficult to determine the quality of a discovered rule based on classification.

A problem with classification is that a rule may, in fact, be a good predictor of actual behavior but not a perfect predictor for every single instance. One way to overcome this problem is to cluster data before trying to discover classification rules. To understand clustering, consider a simple case were two attributes are considered: age and expenditures on clothes. These data points can be plotted on a two-dimensional graph. Given this plot, clustering is an attempt to discover or “invent” new classes based on groupings of similar records. For example, for the above attributes, a clustering of data in the range of $500-700 per year might be found for teenagers from 15 to 19 years old. This cluster could then be treated as a single class. Clusters of data represent subsets of data where members behave similarly but not necessarily the same as the entire population. In discovering clusters, all attributes are considered equally relevant. Assessing the quality of discovered clusters is often a subjective process. Clustering is often used for data exploration and data summarization.

Knowledge Discovery Paradigms

There are a variety of knowledge discovery paradigms, some guided by human users, e.g. rule induction and decision trees, and some based on AI techniques, e.g. neural networks. The choice of the most appropriate paradigm is often application dependent.

On-line analytical processing (OLAP) is a database-oriented paradigm that uses a multidimensional database where each of the dimensions is an independent factor, e.g., product vs. customer name vs. date. There are a variety of operators provided that are most easily understood if one assumes a three-dimensional space in which each factor is a dimension of a vector within a three-dimensional cube. One may use “pivoting” to rotate the cube to see any desired pair of dimensions. “Slicing” involves a subset of the cube by fixing the value of one dimension. “Roll-up” employs higher levels of abstraction, e.g. moving from sales-by-city to sales-by-state, and “drill-down” goes to lower levels, e.g. moving from sales-by-state to sales-by-city. The Data Cube operation computes the power set of the “Group by” operation provided by SQL. For example, given a three dimension cube with dimensions A, B, C, then Data Cube computes Group by A, Group by B, Group by C, Group by A,B, Group by A,C, Group by B,C, and Group by A,B,C. OLAP is used by human operators to discover previously undetected knowledge in the database.

Recall that classification rules involve predicting attributes and the goal attribute. Induction on classification rules involves specialization, i.e. adding a condition to the rule antecedent, and generalization, i.e. removing a condition from the antecedent. Hence, induction involves selecting what predicting attributes will be used. A decision tree is built by selecting the predicting attributes in a particular order, e.g., country of origin first, age second, gender third. The decision tree is built top-down assuming all records are present at the root and are classified by each attribute value going down the tree until the value of the goal attribute is determined. The tree is only as deep as necessary to reach the goal attribute. For example, if no one from Germany buys a particular product, then the value of the goal attribute “Buy?” would be determined (value equals “No”) once the country of origin is known to be Germany. However, if the country of origin is a different value, such as France, it may be necessary to look at other predicting attributes (age, gender) to determine the value of the goal attribute. A human is often involved in selecting the order of attributes to build a decision tree based on “intuitive” knowledge of which attribute is more significant than other attributes.

Decision trees can become quite large and often require pruning, i.e. cutting off lower level subtrees. Pruning avoids “overfitting” the tree to the data and simplifies the discovered knowledge. However, pruning too aggressively can result in “underfitting” the tree to the data and missing some significant attributes.

The above techniques provide tools for a human to manipulate data until some significant knowledge is discovered. Other techniques rely less on human intervention. Instance-based learning involves predicting the value of a tuple, e.g., predicting if someone of a particular age and gender will buy a product, based on stored data for known tuple values. A distance metric is used to determine the values of the N closest neighbors, and these known values are used to predict the unknown value. For example, given a particular age and gender where the tuple value is not known, if among the 20 nearest neighbors, 15 brought the product and 5 did not, then it might be predicted that the value of this new tuple would be “to buy” the product. This technique does not discover any new rules, but it does provide an explanation for the classification, namely the values of the closest neighbors.

The final technique examined is neural nets. A typical neural net includes an input layer of neurons corresponding to the predicting attributes, a hidden layer of neurons, and an output layer of neurons that are the result of the classification. For example, there may be eight input neurons corresponding to “under 25 years old”, “between 25 and 45 years old”, “over 45 years old”, “from Britain”, “from France”, “from Germany”, “male”, and “female”. There would be two output neurons: “purchased product” and “did not purchase product”. A reasonable number of neurons in the middle layer is determined by experimenting with a particular known data set. There are interconnections between the neurons at adjacent layers that have numeric weights. When the network is trained, meaning that both the input and output values are known, these weights are adjusted to given the best performance for the training data. The “knowledge” is very low level (the weight values) and is distributed across the network. This means that neural nets do not provide any comprehensible explanation for their classification behavior—they simply provide a predicted result. Neural nets may take a very long time to train, even when the data is deterministic. For example, to train a neural net to recognize an exclusive—or relationship between two Boolean variables may take hundreds or thousands of training data (the four possible combinations of inputs and corresponding outputs repeated again and again) before the neural net learns the circuit correctly. However, once a neural net is trained, it is very robust and resilient to noise in the data. Neural nets have proved most useful for pattern recognition tasks, such as recognizing hand-written digits in a zip code.

Other knowledge discovery paradigms can be used, such as genetic algorithms. However, the above discussion presents the general issues in knowledge discovery. Some techniques are heavily dependent on human guidance while others are more autonomous. The selection of the best approach to knowledge discovery is heavily dependent on the particular application.

Data Warehousing

The above discussions focused on data mining tasks and knowledge discovery paradigms. There are other components to the overall knowledge discovery process.

Data warehousing is the first component of a knowledge discovery system and is the storage of raw data itself. One of the most common techniques for data warehousing is a relational database. However, other techniques are possible, such as hierarchical databases or multidimensional databases. Data is nonvolatile, i.e. read-only, and often includes historical data. The data in the warehouse needs to be “clean” and “integrated”. Data is often taken from a wide variety of sources. To be clean and integrated means data is represented in a consistent, uniform fashion inside the warehouse despite differences in reporting the raw data from various sources. There also has to be data summarization in the form of a high level aggregation. For example, consider a phone number 111-222-3333 where 111 is the area code, 222 is the exchange, and 3333 is the phone number. The telephone company may want to determine if the inbound number of calls is a good predictor of the outbound number of calls. It turns out that the correlation between inbound and outbound calls increases with the level of aggregation. In other words, at the phone number level, the correlation is weak but as the level of aggregation increases to the area code level, the correlation becomes much higher.

Data Pre-Processing

After the data is read from the warehouse, it is pre-processed before being sent to the data mining system. The two pre-processing steps discussed below are attribute selection and attribute discretization.

Selecting attributes for data mining is important since a database may contain many irrelevant attributes for the purpose of data mining, and the time spent in data mining can be reduced if irrelevant attributes are removed beforehand. Of course, there is always the danger that if an attribute is labeled as irrelevant and removed, then some truly interesting knowledge involving that attribute will not be discovered.

If there are N attributes to choose between, then there are 2^{N} possible subsets of relevant attributes. Selecting the best subset is a nontrivial task. There are two common techniques for attribute selection. The filter approach is fairly simple and independent of the data mining technique being used. For each of the possible predicting attributes, a table is made with the predicting attribute values as rows, the goal attribute values as columns, and the entries in the table as the number of tuples satisfying the pairs of values. If the table is fairly uniform or symmetric, then the predicting attribute is probably irrelevant. However, if the values are asymmetric, then the predicting attribute may be significant.

The second technique for attribute selection is called a wrapper approach where attribute selection is optimized for a particular data mining algorithm. The simplest wrapper approach is Forward Sequential Selection. Each of the possible attributes is sent individually to the data mining algorithm and its accuracy rate is measured. The attribute with the highest accuracy rate is selected. Suppose attribute 3 is selected; attribute 3 is then combined in pairs with all remaining attributes, i.e., 3 and 1, 3 and 2, 3 and 4, etc., and the best performing pair of attributes is selected. This hill climbing process continues until the inclusion of a new attribute decreases the accuracy rate. This technique is relatively simple to implement, but it does not handle interaction among attributes well. An alternative approach is backward sequential selection that handles interactions better, but it is computationally much more expensive.

Discretization involves grouping data into categories. For example, age in years might be used to group persons into categories such as minors (below 18), young adults (18 to 39), middle-agers (40-59), and senior citizens (60 or above). Some advantages of discretization is that it reduces the time for data mining and improves the comprehensibility of the discovered knowledge. Categorization may actually be required by some mining techniques. A disadvantage of discretization is that details of the knowledge may be suppressed.

Blindly applying equal-weight discretization, such as grouping ages by 10 year cycles, may not produce very good results. It is better to find “class-driven” intervals. In other words, one looks for intervals that have uniformity within the interval and have differences between the different intervals.

Data Post-Processing

The number of rules discovered by data mining may be overwhelming, and it may be necessary to reduce this number and select the most important ones to obtain any significant results. One approach is subjective or user-driven. This approach depends on a human's general impression of the application domain. For example, the human user may propose a rule such as “if the applicant has a higher salary, then the applicant has a greater chance of getting a loan”. The discovered rules are then compared against this general impression to determine the most interesting rules. Often, interesting rules do not agree with general expectations. For example, although the conditions are satisfied, the conclusion is different than the general expectations. Another example is that the conclusion is correct, but there are different or unexpected conditions.

Rule affinity is a more mathematical approach to examining rules that does not depend on human impressions. The affinity between two rules in a set of rules {Rᵢ} is measured and given a numerical affinity value between zero and one, called Af(Rₓ,R_{y}). The affinity value of a rule with itself is always one, while the affinity with a different rule is less than one. Assume that one has a quality measure for each rule in a set of rules {Rᵢ}, called Q(Rᵢ) A rule Rⱼ is said to be suppressed by a rule Rₖ if Q(Rⱼ)<Af(Rⱼ,Rₖ)*Q(Rₖ). Notice that a rule can never be suppressed by a lower quality rule since one assumes that Af(Rⱼ,Rₖ)<1 if j ¹ k. One common measure for the affinity function is the size of the intersection between the tuple sets covered by the two rules, i.e. the larger the intersection, the greater the affinity.

Data Mining Summary

The discussion above has touched on the following aspects of knowledge processing: data warehousing, pre-processing data, data mining itself, and post-processing to obtain the most interesting and significant knowledge. With large databases, these tasks can be very computationally intensive, and efficiency becomes a major issue. Much of the research in this area focuses on the use of parallel processing. Issues involved in parallelization include how to partition the data, whether to parallelize on data or on control, how to minimize communications overhead, how to balance the load between various processors, how to automate the parallelization, how to take advantage of a parallel database system itself, etc.

Many knowledge evaluation techniques involve statistical methods or artificial intelligence or both. The quality of the knowledge discovered is highly application dependent and inherently subjective. A good knowledge discovery process should be both effective, i.e. discovers high quality knowledge, and efficient, i.e. runs quickly.

Integrating Spatial Analysis Including Global Positioning and Discovery Based Data Mining Analysis to Ascertain the Proper Positioning of Products in a Retail Environment

As noted above, retail establishments desire a form of data analysis that discovers relationships between product placement and the choice of product purchases by a customer. By taking advantage of the realization that the many databases owned by a retail establishment contain spatial information, the present invention integrates spatial analysis methodologies with data mining methodologies. This integration of methodologies helps solve the problem of understanding a customer's buying habits in a retail establishment.

In a retail environment, one may categorize business data using three aspects that facilitate the integration of spatial analysis methodologies with data mining methodologies. One aspect is the customer as an individual, i.e. the fact that the retail establishment may have a database containing personal information about the customer. For example, many retail establishments have preferred customer cards for which a customer may register by providing some personal information, such as age, address, occupation, etc. In return for the personal information, the retail establishment provides a card with a magnetic strip that may be swiped upon checkout when purchasing products. The customer receives special bonuses and coupon incentives for using the card, and the retail establishment receives the ability to aggregate information concerning the customer's buying habits.

The second aspect of business data is the products that a customer might buy. As products are received from vendors for inventory within a retail establishment, the vendor may supply electronic data concerning the products that the retail establishment stores in one or more databases, including product descriptions, product UPC codes, quantities, prices, etc. Retailers may create their own databases containing product-related information.

The third aspect of business data is the spatial relationship between products within the retail establishment's physical space, which may be termed the retail space. As products are placed within the retail space, which may include shelves, bins, racks, coolers, displays, etc., as necessary for the particular products and the particular retail establishment, the location of the product is registered within a database. By maintaining knowledge of the exact location of products within the retail space, a retail establishment takes a first step to facilitating ease of shopping by a customer who may be interested in related products.

Discovery-based data mining allows for the understanding of the customer and the products that the customer may buy together. As noted above in the description of general data mining techniques, data mining alone may provide interesting relationships. For example, data mining within the purchase transactions of a retailer may reveal a rule such as middle-aged men tend to buy at least two dessert items when they make a food purchase at a particular grocery store between 6 p.m. and 10 p.m. However, a grocery store may have dessert items placed at several locations throughout its retail space, and data mining alone cannot provide further information concerning relationships between the locations of the purchased dessert items. For example, a grocery store may have dessert items located in a freezer section, a dairy section, a bakery section, and a candy confection section, and the grocery store operator may be interested to know that the dessert items which tend to be purchased together do not lie within thirty feet of each other, i.e. middle-aged men seem to make an extra effort to walk between these sections looking for particular items.

Spatial analysis using GIS utilizing the data collected by the data collection devices GPS, LPS, and EGPS integrated with the product/customer relationships discovered using data mining allows for the relationship of these products in the retail environment to be monitored and analyzed, which allows for the proper evaluation of related product purchases by certain customers and how their position in the store may influence those purchases. Continuing with the above example, spatial analysis of the customer paths and item location determines the exact locations of the dessert items within the retail space, their relative placement to one another, and the movement of customers throughout a retail space in relation to these products. The interaction and selection of products by customers may be spatially analyzed using analyses such as “what-if” concerning another position in the store to determine if an alternative spatial relationship of products might be more profitable. These spatial relationships may be integrated with the data relationships discovered through data mining to determine additional information concerning purchases by customers. This knowledge then provides the retail establishment with the direction necessary to enhance such purchases through the co-location of products that appear in the same shopping baskets consistently.

Spatial analysis is a means by which one can integrate absolute positioning of objects in space such that a distance and direction between each can be determined. Once this determination has been made then the positions of these objects can be mapped. There are numerous algorithms that can take advantage of this data to calculate time between various positions, preferential paths, etc. This technology allows one to measure the frequency of certain paths being taken, map those with relationship to stationary objects such as products or facilities, monitor changes in path patterns as a result of object position changes, and model alternatives of actions and processes that may cause the implementation of new paths that are financially more attractive to a retail establishment. Similar technology has been used for a number of years by urban planners, scientists, resource managers and others to monitor and analyze environmental parameters.

By employing a global positioning system (GPS), a database may store accurate establishment of positions of products within the store. In addition, GPS may be used to record paths and patterns of browsing and shopping of store patrons. GPS systems are well-known, and the accuracy of the position information varies depending upon the application. Although a GPS signal from a satellite may only provide location accuracy to within several yards, GPS data may be locally enhanced within the retail space with local positioning transmitters, such as Enhanced GPS (EGPS) and detectors so that the retail establishment has position information which is accurate to within inches or less. By utilizing the present invention of the combination of global positioning, spatial analysis, and data mining, it is possible for the first time to track customers through stores and monitor their buying habits and procedures, thus allowing for a better positioning of products to make it easier for customers to select and purchase things that they need.

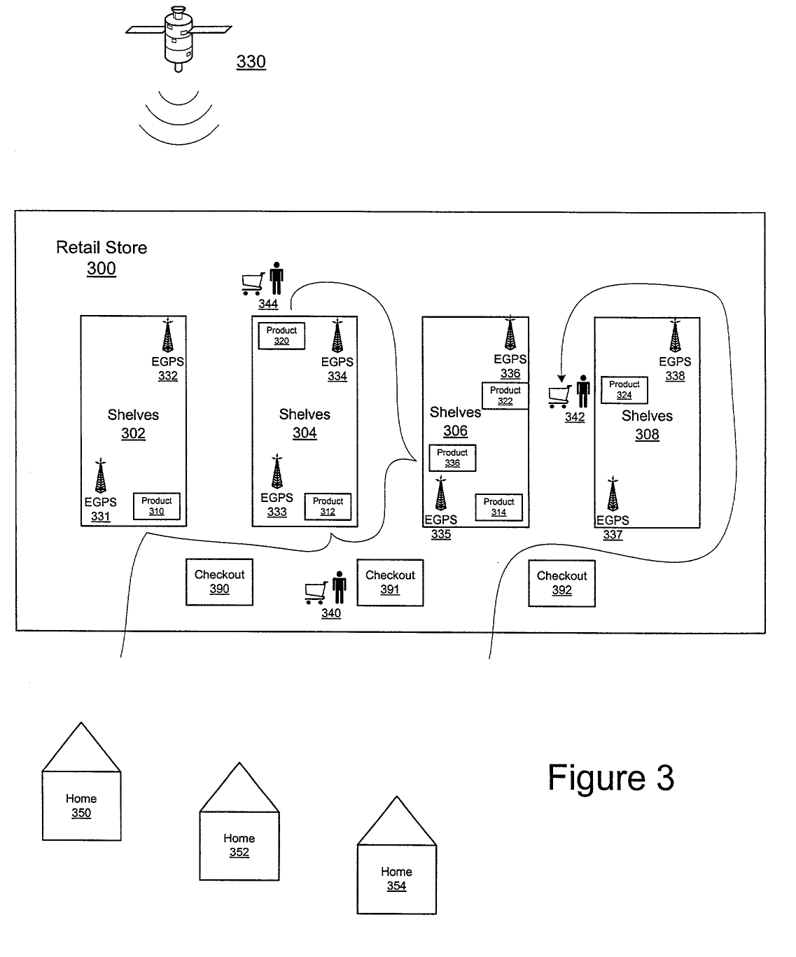

With reference to FIG. 3, a diagram depicts various objects upon which a retail establishment may gather information to determine spatial relationships. Retail establishment 300, which may be a grocery store, has shelves 302-308 which contain aisles of products.

Products 310-324 reside at specific locations on these shelves. As the products are placed on the shelves, employees of the store may scan the UPC bar codes of the products. When a product is scanned, the location of the placement of the product is determined and stored in an appropriate database. If a GPS signal is adequately strong and accurate, the scanning unit may be able to receive the GPS signal from satellite 330. Alternatively, local EGPS transmitters 331-338 within the retail space will provide signals that enhance or replace the satellite signal and from which a precise location of a product in the store may be determined. The position identifying system used throughout the present invention may vary, and the examples provided above should not be interpreted as limitations with respect to the present invention.

Customer 340 is located at checkout counter 391, one of several checkout counters 390-392 in the retail store. The products within the basket of customer 340 are recorded in a transaction database along with other associated purchase information for the customer.

Customer 342 has traced a path through the store and has stopped at a location at which the customer has selected products 322 and 324. The path of the customer through the store may be traced in a variety of manners. Each shopping basket may have a GPS receiver that records its movement throughout the store; at specific time points, possibly once per second, the location of the basket is recorded. Alternatively, preferred customers may be given baskets that include such receivers so that only movements of certain customers are analyzed. When the customer checks out, the path storing device on the basket is wirelessly queried to retrieve the path of the customer, and the identity of the customer is determined through the financial transaction at checkout, either by swiping a preferred customer card, by using a credit card, or by using some other identification. As the shopping basket is returned to a basket storage location within the store, the storage device may be reset in preparation for its use by another patron.

In a different mode of operation, the basket may have an interactive display that the customer activates by swiping a preferred customer card. Once the customer is identified with this action, the identity of the customer that traces a path through the store is then known, and the path information is eventually stored along with the customer's purchase information.

The methods of identifying the customer and the customer's path through the retail space described herein are provided as examples and should not be interpreted as limiting the invention.

Customer 344 traces a unique path through the retail space that is different from other customers. As is shown in the figure, customer 344 stops in front of products 310, 312, 316, 318, and 320, respectively. At each of these locations, customer 344 may or may not select the particular products for purchase. The path for customer 344 is later stored along with purchase information.

Even if customer 344 did not select one or more of products 310, 312, 316, 318, or 320, however, the fact that the customer paused in front of the products may be significant for marketing purposes. For example, products 310 and 312 are located at the highly visible endcaps of the aisles. These locations are frequently reserved by stores for special promotions. Even if the customer does not choose one of the products at these locations, the retail establishment derives some value in knowing that the display attracted the attention of the customer. During data analysis, the retailer may discover that customer 344 and similar customers are not generally purchasers of these specially displayed products, but the fact that the retailer was able to attract the attention of such customers and possibly induce some of them to buy the product informs the retailer of some correlation between the products' locations with the retail space and their appeal to certain customers.

Homes 350, 352, and 354 are shown as the points of origin for customers 340, 342, and 344. The retail establishment stores the address of a preferred customer in association with other preferred customer information. In addition, the address of certain customers may be determined through credit card transactions, etc. The addresses provide additional spatial information which may be correlated with the purchasing decisions of the customers during data post-processing. The information about the demographics (age, children, gender, etc.) may then be gathered about these customers and integrated with the other in-store data to allow one to segment these customers. If these customers are good customers and have a certain product that they purchase, e.g. a barbeque, then an advertisement may be sent to this customer that gives the customer special compensation toward the purchase of charcoal, an apron, etc. Since the information about the customer is extensive, the chances that the customer will take advantage of the offer should be great, which in turn would give a greater than expected acceptance rate of an offer for supplemental products that would be associated with an earlier purchase.

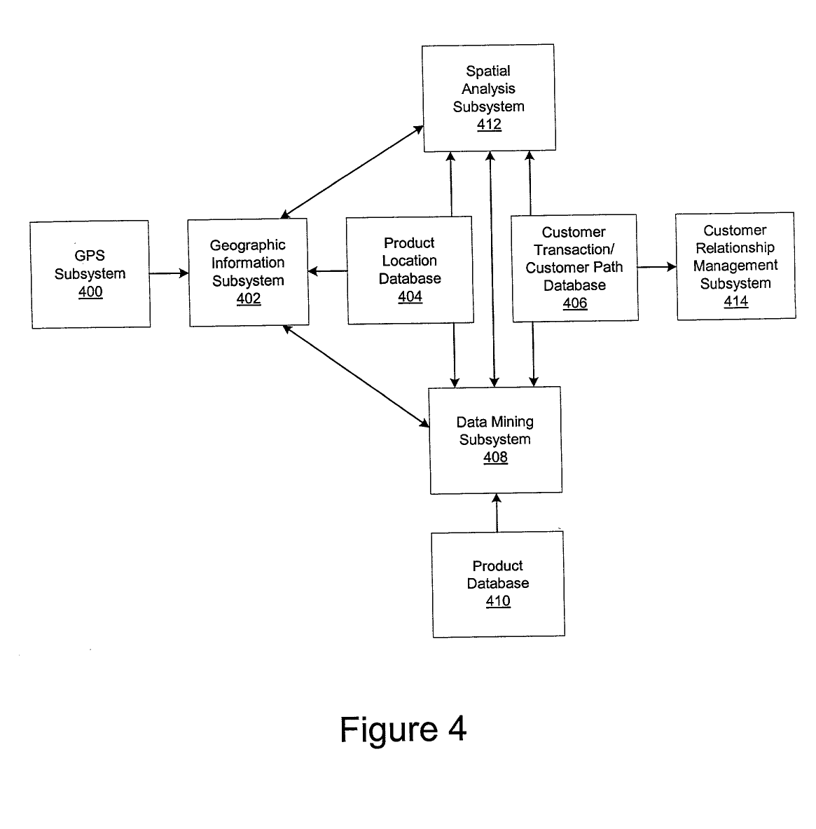

With reference now to FIG. 4, a block diagram depicts the components that may be used in a data processing system implementing the present invention. GPS subsystem 400 provides precise locations of the placement of products within the retail space. Geographic Information Subsystem (GIS) 402 uses the positioning information from the GPS subsystem to correlate the position of the products within the retail space as stored within product position database 404 and the paths of customers through the retail space as stored within customer transaction database 406. Data mining subsystem 408 uses product database 410, customer transaction database 406, and product location 404 to discover relationships between the placement of products, the products chosen for purchase by customers, and the paths of customers within the retail space. Spatial analysis subsystem 412 uses the customer path information in customer transaction database 406 and product location database 404 to process, plot, and display spatial information.

GIS 402, data mining subsystem 408, and spatial analysis subsystem 412 transfer information as appropriate. GIS 402 may process position information as necessary for either spatial analysis subsystem 412 or data mining subsystem 408. Spatial analysis subsystem 412 receives relationship data from data mining subsystem 410 for plotting and displaying spatial relationships and may return feedback information concerning spatial relationships to data mining subsystem 408. Spatial analysis subsystem 412 and data mining subsystem 408 may provide results to customer relationship management (CRM) subsystem 414 that incorporates the results into marketing plans for the retail establishment.

Other databases may be provided, or the databases above may be combined in alternate arrangements of information. The examples provided above are not meant as limitations with respect to the present invention.

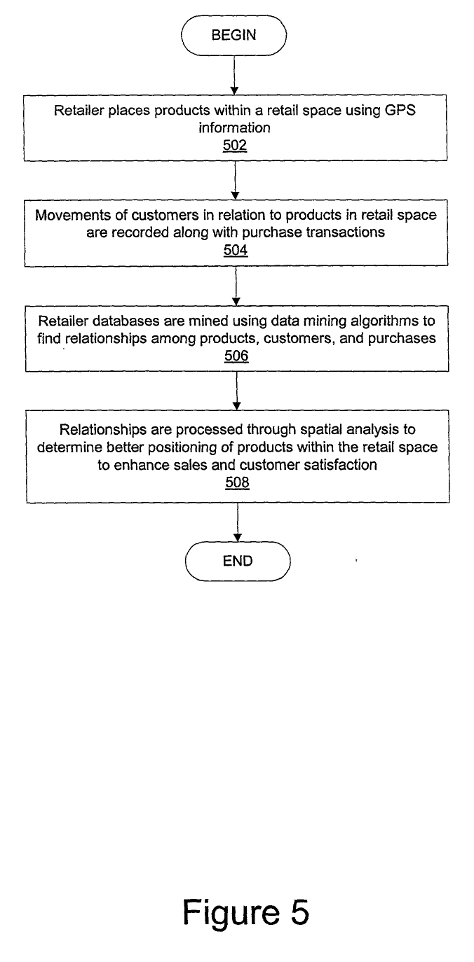

With reference now to FIG. 5, a flowchart depicts a process for integrating spatial analysis with data mining. The process begins with precise placement of products within a retail space using GPS information (step 502). As customers trace paths within the retail space, their movements are recorded into a database along with their purchase transactions (step 504). These databases are then mined using data mining algorithms to find relationships among products, customers, and purchases (step 506). Potentially valuable data relationships are then processed through spatial analysis to determine whether the location of products within the retail space contributes or hinders particular relationships among customers and products (step 508).

By knowing the different attributes of the customers, relating that information to the products they buy, and then further understanding the store geography as it relates to paths through the store, and the regional geography from which the customer has come, some interesting relationships may be determined. For example, it may be found that customers who shop the store and come from greater than 5 miles, buy only large containers of products whereas customers that come from less than 5 miles away do not tend to by large containers of products. These may be limited to only a few different kinds of products eg. soaps, flour, etc. If this information was used with specific advertising that featured compensation for the large quantity products in advertisements focused on customers that shop at the store who come from greater than 5 miles from the store, and the same advertisement featuring compensation for other than the large quantity products of the same brands was focused on customers who come from less than 5 miles from the store, then a more targeted campaign with an expected higher customer acceptance could be conducted. Then, if the large quantity products were colocated in the store separate from the small quantity products, the products featured to the two different audiences could have an associated store map that would show these two audiences preferred paths to their respective products. These paths could be varied through the store based upon the other products purchased at the same time by the two different audiences and thus allow them to buy other complementary items at the same time, e.g. 64 oz. barbeque sauce and chicken or 15 gallons of oil and large engine oil filters, 16 oz. of barbeque sauce and pork ribs or 2 quarts of oil and oil filters for compact cars.

Another application might be associated with age of the customer. One might determine using either a demographic clustering algorithm or classification algorithm provided by a data mining analysis that customers that are younger than 25 never visit the lamp department but always visit the sofa and accessories department if they come to the store from less than 15 miles away, whereas customers that are older than 25 always visit the lamp department and also the china department no matter what their distance from the store. Advertisements to these two different groups would be different in that the advertising material sent to the younger than 25 group of shoppers would always feature specialties in the sofa and accessories department if they live greater than 15 miles away and the advertisements sent to shoppers that are over 25 no matter how far they lived from the store would feature specialties in the lamp and china departments.

The integration of spatial relationships with data-mined relationships provides marketing guidance to a retailer in several ways. First, a retailer may find a strong relationship between the sales of one particular product and its location over time by tracking sales of the product and analyzing how these sales are either enhanced or diminished as the position of the product changes over time.

A second but potentially much more valuable set of market guidance relationships involves the relationship between a product and a customer's behavior regarding the product. Through traditional data mining of purchase transactions and customer information, a retailer may discover that customers from a specific local region near the retail establishment are better customers than other customers from other regions. However, without performing spatial analysis, the retailer cannot relate the layout of a store and the placement of products within the store to particular customers. By rearranging product placement and display layouts over time, the retailer may discover that particular placements and layouts induce particular shopping behavior in different customers or sets of customers.

For example, a retailer may desire to organize all of its stores in a uniform manner so that when a customer visits any of the stores, the customer can easily find a product in the same relative location in all stores. However, a set of drop-in customers may not be the retailer's best customer, either in terms of amount of sales or in frequency of visits. A retailer primarily wants to increase sales, so a uniform layout for all stores may or may not be the best approach. The ultimate goal of the retailer should be to make the largest amount of sales in the shortest amount of time from the best customers of the retailer. The retailer may experiment with product placement and product layout and spatially analyze the purchasing behavior of customers in order to maximize a beneficial relationship between the customers and the retailer.

The present invention may also be applied to a more general category of persons and products, such as products located within a warehouse. Data mining may be applied to transactions, such as purchase orders of items, and spatial analysis may be applied to persons retrieving items in order to enhance the efficiency of those persons within the warehouse.

The advantages of the present invention should be apparent in view of the detailed description provided above. One can conclude that the need for a tool to assess spatial relationships of products allows one to enhance product purchases by individual customers by allowing for the assessment of relative location of products one to another. This assessment is very difficult to impossible without the plotting of these product locations on a map and observing the resulting buying patterns created when products are moved from one location to another. Global positioning allows for the tracking of patterns of customers in a store and provides the data that will be used in the spatial analysis and discovery-based data mining with respect to customer patterns and product positions. Using discovery-based data mining algorithms that address the association of products, classifications of behaviors, and prediction of the propensity to buy or accept an offer allows for the differences between customer buying patterns and how the buying patterns change with changes in location of products to be understood. Finally, using this knowledge to develop new store layouts and product locations treats customers in a way that it makes it easy for them to shop for related products and provides happier customers that will purchase more products in a shorter period of time. Data is turned to knowledge, and this knowledge is used to better serve customers.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links. Also, it should be kept in mind that position capturing devices other than GPS might be used to capture positioning information. These might include remote sensing capturing sensors that record the position of images produced from products or persons directly.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for determining data relationships of data associated with product placement in a retail space, the method comprising the computer-implemented steps of:
determining locations of products within the retail space using a position identifying system;
identifying customers within the retail space;
recording paths of customers through the retail space using the position identifying system;
identifying products chosen for purchase by the customers during the paths of the customers through the retail space; and
associating the locations of products within the retail space with the paths of the customers through the retail space to form a set of spatial relationships.

2. The method of claim 1 further comprising:
employing data mining algorithms to generate input data for forming the set of spatial relationships.

3. The method of claim 1 further comprising:
employing spatial analysis algorithms to form the set of spatial relationships.

4. The method of claim 1 wherein the position identifying system comprises a global positioning system or other remote sensing device.

5. The method of claim 1 wherein the position identifying system comprises a local positioning system that may or may not be associated with a global positioning system.

6. A method for determining data relationships of data associated with product placement in a retail space, the method comprising the computer-implemented steps of:
identifying patterns of customers in the retail space;
identifying locations of products within the retail space; and
associating the patterns of customers with the locations of products to form a set of spatial relationships.

7. The method of claim 6 further comprising:
selecting locations for products in the retail space based on the set of spatial relationships.

8. The method of claim 7 further comprising:
identifying locations of products relocated within the retail space based on the selected locations; and
associating the patterns of customers with the locations of relocated products to form a second set of spatial relationships.

9. The method of claim 6 further comprising:
employing data mining algorithms to generate input data for forming the set of spatial relationships.

10. The method of claim 6 further comprising:
employing spatial analysis algorithms to form the set of spatial relationships.

11. The method of claim 6 further comprising:
identifying patterns of customers and locations of products within the retail space comprises using a position identifying system.

12. The method of claim 11 wherein the position identifying system comprises a local positioning system that may or may not be associated with a global positioning system.

13. The method of claim 11 wherein the position identifying system comprises a global positioning system or some other means of sensing position of objects of interest.

14. A method for determining data relationships of data associated with product placement, the method comprising the computer-implemented steps of:
identifying patterns of persons within a physical space;
identifying locations of products within a physical space; and
associating the patterns of persons with the locations of products to form a set of spatial relationships.

15. The method of claim 14 wherein the physical space is a warehouse of products.

16. A data processing system for determining data relationships of data associated with product placement in a retail space, the data processing system comprising:
determining means for determining locations of products within the retail space using a position identifying system;
first identifying means for identifying customers within the retail space;
recording means for recording paths of customers through the retail space using the position identifying system;
second identifying means for identifying products chosen for purchase by the customers during the paths of the customers through the retail space; and
associating means for associating the locations of products within the retail space with the paths of the customers through the retail space to form a set of spatial relationships.

17. The data processing system of claim 16 further comprising:
first employing means for employing data mining algorithms to generate input data for forming the set of spatial relationships.

18. The data processing system of claim 16 further comprising:
second employing means for employing spatial analysis algorithms to form the set of spatial relationships.

19. The data processing system of claim 16 wherein the position identifying system comprises a global positioning system.

20. The data processing system of claim 16 wherein the position identifying system comprises a local positioning system.

21. A data processing system for determining data relationships of data associated with product placement in a retail space, the data processing system comprising:
first identifying means for identifying patterns of customers in the retail space;
second identifying means for identifying locations of products within the retail space; and
first associating means for associating the patterns of customers with the locations of products to form a set of spatial relationships.

22. The data processing system of claim 21 further comprising:
selecting means for selecting locations for products in the retail space based on the set of spatial relationships.

23. The data processing system of claim 22 further comprising:
third identifying means for identifying locations of products relocated within the retail space based on the selected locations; and
second associating means for associating the patterns of customers with the locations of relocated products to form a second set of spatial relationships.

24. The data processing system of claim 21 further comprising:
first employing means for employing data mining algorithms to generate input data for forming the set of spatial relationships.

25. The data processing system of claim 21 further comprising:
second employing means for employing spatial analysis algorithms to form the set of spatial relationships.

26. The data processing system of claim 21 further comprising:
fourth identifying means for identifying patterns of customers and locations of products within the retail space comprises using a position identifying system.

27. The data processing system of claim 26 wherein the position identifying system comprises a local positioning system.

28. The data processing system of claim 26 wherein the position identifying system comprises a global positioning system.

29. A data processing system for determining data relationships of data associated with product placement, the data processing system comprising:
first identifying means for identifying patterns of persons within a physical space;
second identifying means for identifying locations of products within a physical space; and
associating means for associating the patterns of persons with the locations of products to form a set of spatial relationships.

30. The data processing system of claim 29 wherein the physical space is a warehouse of products.
